(19) United States
(12) Patent Application Publication
(10) Pub. No.: US 2025/0178084 A1
(43) Pub. Date: Jun. 5, 2025

(54) CEMENTED CARBIDE POWDER FOR BINDER JET ADDITIVE MANUFACTURING

(71) Applicants: Hyperion Materials & Technologies, Inc., Worthington, OH (US); Diamond Innovations, Inc., Worthington, OH (US)

(72) Inventors: Oscar Carrasco Cozar, Caldes de Montbui (ES); Marco Tulio Mendez Aguilar, Mollet Del Vallès (ES); Luis Fernando Garcia, Barcelona (ES); Emil Stoyanov, Livermore, CA (US); Andrew Gledhill, Westerville, OH (US)

(21) Appl. No.: 18/846,142

(22) PCT Filed: Mar. 1, 2023
(86) PCT No.: PCT/US2023/063466

§ 371 Date: Sep. 11, 2024

Related U.S. Application Data
(60) Provisional application No. 63/330,451, filed on Apr. 13, 2022.

(51) Int. Cl. B22F 1/12; B22F 10/14; B22F 10/64; B22F 12/13; B28B 1/00; B33Y 10/00; B33Y 40/10; B33Y 70/10

(52) U.S. Cl. CPC B22F 1/12; B22F 10/14; B22F 10/64; B22F 12/13; B28B 1/001; B33Y 10/00; B33Y 40/10; B33Y 70/10; B22F 2201/11; B22F 2301/15; B22F 2302/10

(57) ABSTRACT

Provided is a method of manufacturing a three-dimensional (3D) object by forming a printable cemented carbide powder with a full density by a dual sintering cycle process. The formed fully densified printable cemented carbide powder is next used in binder jet additive manufacturing to 3D print the object.

### FIELD OF THE DISCLOSURE

The present disclosure relates to a method of manufacturing a three-dimensional (3D) object by binder jet additive manufacturing.

### BACKGROUND

Additive layer manufacturing (ALM) typically encompasses processes, in which, digital 3-dimensional (3D) design data is employed to 3D print a physical article, or a component by way of forming successive layers by sequential material and liquid binding agent deposition followed by processing. Growing body of evidence suggests the notion that the ALM market is maturing rapidly, and as a consequence of this, has sparked mounting interest especially for manufacturers to construct physical articles and components in a timely manner. As a matter of fact, myriad choices of techniques have been developed that traditionally fall under the general umbrella of ALM. Still in this regard, conventional 3D techniques may include the following, but not limited to for example, stereo lithography incorporating UV lasers to cure photopolymers, inkjet printers utilizing UV radiation to polymerize photo-monomers and photo-oligomers, metal sintering (e.g. such as selective laser sintering and direct metal laser sintering), fused deposition modeling (FDM, based on extrusion technology), and deposition of liquid binders onto powders.

In the context of ALM, such 3D printing technologies have emerged as attractive tools for manufacturing physical articles and components in a variety of different fields, such as for example, architecture, construction (AEC), industrial design, automotive, aerospace, military, engineering, dental and medical industries, biotech (e.g. human tissue replacement), fashion, footwear, jewelry, eyewear, education, geographic information systems, food, and many other fields. A compelling incentive for adopting ALM is that it offers an efficient and a cost-effective alternative to traditional, and more routinely used article fabrication techniques that are based solely on molding processes. With ALM, the significant time and expenses of mold, and/or die construction, and other tooling can be obviated. Indeed, ALM techniques offer an advantageous use of materials by permitting recycling in the process and obviating the necessity of employing mold lubricants and coolants. Simply put, ALM favorably provides manufacturers with a whole spectrum of choices and freedom in article design. Importantly, the outcome is that articles having highly complex shapes can be fabricated by avoiding significant expenses, while at the same time, not being cumbersome.

In the platform of ALM technologies to 3D print objects, binder jet additive manufacturing or simply binder jetting is a next-generation technique encompassing a well-defined ALM process. An industrial printhead selectively deposits a liquid binding agent onto a thin layer of powdered particles, which may be either metal, sand, ceramics, or composites. The process is repeated sequentially, such that successive layers are added by using a specifically created map from a digital design file, until the object is eventually 3D printed and cured.

Thus the liquid binding agent acts as an adhesive much like a glue between the plurality of added accumulated mass of powdered layers. The binder is commonly in a liquid form, while the build material is in a powder form. A print-head moves horizontally along the x and y axes of the machine and deposits alternating layers of the build material and the liquid binding material in a sequential manner. After each successive layer, the object being 3D printed is lowered on its build platform.

One inherent non-trivial obstacle generally faced with has been that a pore-free part cannot be obtained after furnace sintering. As such, for the cemented carbide powders, a trade-off exists between a good and sufficient flowability (i.e. particles should ideally not sinter one to the other) and the production of high enough density commonly required for binder jetting. Thus, it is imperative to consider this trade-off when manufacturing cemented carbide powders for binder jetting purposes.

In view of the foregoing, there is therefore a need in the art of ALM for a method of fabricating high density cemented carbides used in binder jetting to 3D print an object, which is directed toward solving the aforementioned issue.

### SUMMARY

According to a first aspect, provided is a method of manufacturing a three-dimensional (3D) object, which includes preparing a slurry composition including a ceramic hard phase powder, a metallic binder phase powder and an organic binder in a milling liquid. The slurry composition is next milled to obtain a slurry blend, which slurry blend, is thereafter spray-dried to obtain a RTP powder. After sieving the RTP powder, the RTP powder is next pre-sintered in a first cycle to obtain a densification of the RTP powder. The pre-sintered RTP powder is then sintered in a second cycle to form a printable powder having an enhanced densification. After sieving the formed printable powder, the formed printable powder is subjected to binder jetting to 3D print a green body. The 3D printed green body is thereafter cured and sintered, to finally form the 3D object.

Optionally, the RTP powder is free-flowing.

Optionally, the pre-sintering in the first cycle is performed at a temperature starting from about 550° C. and ending at about 1250° C.

Optionally, the pre-sintering in the first cycle is performed in an atmosphere with a hydrogen pressure up to about 35 mbar applied with a flow of hydrogen up to about 6000 liters/hour.

Optionally, the pre-sintering in the first cycle is performed for about 15 minutes to about 30 minutes.

Optionally, the pre-sintering in the first cycle is performed for about 30 minutes to about 45 minutes.

Optionally, the sintering in the second cycle is performed at a temperature starting from about 550° C. and ending at about 1250° C.

Optionally, the sintering in the second cycle is performed in an atmosphere with an argon pressure up to about 50 mbar applied with a flow of argon up to about 300 liters/hour.

Optionally, the sintering in the second cycle is performed for about 15 minutes to about 30 minutes.

Optionally, the sintering in the second cycle is performed for about 30 minutes to about 45 minutes.

Optionally, a yield of the formed printable powder is from about 60% to about 90%.

Optionally, a yield of the formed printable powder is from about 70% to about 90%.

Optionally, a yield of the formed printable powder is from about 80% to about 90%.

Optionally, a yield of the formed printable powder is from about 85% to about 90%.

Optionally, a yield of the formed printable powder is at least 90%.

Optionally, an apparent density of the RTP powder and the printable powder ranges from at least about 5 g/cm³ to about 15 g/cm³.

Optionally, the ceramic hard phase includes one or more of tungsten carbide (WC), titanium cabide (TIC), tantalum carbide (TaC), niobium carbide (NbC), vanadium carbide (VC), zirconium carbide (ZrC), molybdenum carbide (Mo₂C) or hafnium carbide (HfC), or any combinations thereof.

Optionally, the ceramic hard phase includes WC.

Optionally, the metallic binder phase powder includes cobalt.

Optionally, the RTP powder is sieved through a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, a 140-mesh screen, or a 200-mesh screen.

Optionally, the printable powder is sieved through a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, 140-mesh screen, 200-mesh screen, 230-mesh screen, 270-mesh screen, a 325-mesh screen, or a 400-mesh screen.

Optionally, curing the 3D printed green body is performed at a temperature starting from about 150° C. and ending at about 180° C.

Optionally, curing the 3D printed green body is performed at a temperature starting from about 180° C. and ending at about 200° C.

Optionally, curing the 3D printed green body is performed for up to about 6 hours.

Optionally, sintering the cured 3D printed green body is performed at a temperature starting from 1500° C. and ending at about 1560° C.

Optionally, sintering the cured 3D printed green body is performed at a temperature starting from 1560° C. and ending at about 1600° C.

Optionally, the printable powder is fully densified.

Other systems, methods, features and advantages will be, or will become apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments of the disclosure. It is to be understood that both the foregoing general description and the following detailed description of the present disclosure are examples and explanatory and are intended to provide further explanation of the disclosure as claimed.

### BRIEF DESCRIPTION OF THE DRAWING

The accompanying drawing, which is included to provide a further understanding of the subject matter and is incorporated in and constitutes a part of this specification, illustrates implementations of the subject matter and together with the description serves to explain the principles of the disclosure.

FIG. 1 is a flow diagram showing the individual process steps of manufacturing a high density cemented carbide powder for binder jetting to 3D print an object in accordance with an exemplary embodiment of the present subject matter.

### DETAILED DESCRIPTION

Unless defined otherwise all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

The following definitions set forth the parameters of the described subject matter.

As used herein this disclosure, the term “Additive layer manufacturing (ALM)” refers to processes, in which, digital 3-dimensional (3D) design data is employed to fabricate a physical article, or a component in various successive layers by alternating and sequential powdered material and liquid binding agent deposition and processing methodologies. With the recent convergence of breakthrough technologies in 3D printing objects, for example fused deposition modeling (FDM) and binder jetting are examples of such next-generation ALM processes. An industrial printhead selectively deposits a liquid binding agent onto a thin layer of powdered particles, which may be either metal, sand, ceramics, or composites. The process is repeated sequentially, such that successive layers are added by using a specifically created map from a digital design file until the object is eventually 3D printed and cured.

As used herein this disclosure, the term “RTP powder” herein refers to a milled and a spray-dried pressable cemented carbide powder including a mixture of a ceramic hard phase and a metallic binder phase including cobalt typically having a particle size spanning from about 10 microns to about 250 microns. The RTP powder is densified after being sieved, which densification is facilitated by a first pre-sintering consolidation step. This is then followed by a second sintering cycle process to ultimately enhance, and to further densify the particle density of the cemented carbide powder, thus resulting in a fully densified “printable powder.” Thus, the further densification of the RTP powder by the second sintering cycle forms the fully densified printable powder. After undergoing sieving, the formed fully densified printable powder is next used in binder jet additive manufacturing to 3D print a green body.

As used herein this disclosure, the term “curing” refers to a chemical or a physical process that produces toughening or hardening by cross-linking of chains. Curing may involve a chemical reaction such as polymerization, or a physical reaction like evaporation leading to more stable cross-linking of chains.

As used herein this disclosure, the term “sintering” refers to a process, where heating under controlled pressure is conducted to minimize the surface of a particulate system, which is associated with generation of bonds between neighboring particles or granules, and shrinkage of the aggregated particles or granules. Compacting and forming a dense bulk mass is performed by heating the particles without melting them to the point of liquefaction. The atoms in the particles diffuse across the boundaries of the particles, thus fusing the particles together and creating one solid bulk piece.

As used herein this disclosure, the term “sphere” refers to a solid round figure with every point on its surface being equidistantly located from its center.

As used herein this disclosure, the term “wt. %” refers to a given weight percent based on the total weight of a high-density cemented carbide for binder jet additive manufacturing to 3D print an object, unless specifically indicated otherwise.

As used herein this disclosure, the term “D50” refers to a particle size corresponding to 50% of the volume of the sampled particles being smaller than and 50% of the volume of the sampled particles being greater than the recited D50 value. Similarly, the term “D90” refers to a particle size corresponding to 90% of the volume of the sampled particles being smaller than and 10% of the volume of the sampled particles being greater than the recited D90 value. The term “D10” refers to a particle size corresponding to 10% of the volume of the sampled particles being smaller than and 90% of the volume of the sampled particles being greater than the recited D10 value. A width of the particle size distribution can be calculated by determining the span, which is defined by the equation (D90-D10)/D50. The span gives an indication of how far the 10 percent and the 90 percent points are apart normalized with the midpoint.

To determine mean particle sizes from a given particle size distribution for a sintered microstructure, a skilled artisan would be readily familiar with the ISO 4499-2:2008 standard. The ISO 4499-2:2008 standard provides guidelines for the measurement of hard metal grain size by metallographic techniques employing optical or electron microscopy. It is intended for sintered WC/Co hard metals containing primarily WC as the ceramic hard phase. It is also intended for measuring the grain size and distribution by a linear-intercept technique.

To further supplement the ISO 4499-2:2008 standard, a skilled artisan would equally know about the ASTM B390-92 (2006) standard. This standard is used for empirically conducted visual comparison and classification of the apparent grain size and distribution of cemented tungsten carbides that typically contain cobalt as a metallic binder in the binder phase.

Cemented carbide grades can be classified according to the grain size. Different types of grades for different materials have been defined as nano, ultrafine, submicron, fine, medium, medium coarse, coarse and extra coarse. As used herein this disclosure, the term (I) “nano grade” is defined as a material with a grain size of less than about 0.2 μm; (II) “ultrafine grade” is defined as a material with a grain size from about 0.2 μm to about 0.5 μm; (III) “submicron grade” is defined as a material with a grain size from about 0.5 μm to about 0.9 μm; (IV) “fine grade” is defined as a material with a grain size from about 1.0 μm to about 1.3 μm; (V) “medium grade” is defined as a material with a grain size from about 1.4 μm to about 2.0 μm; (VI) “medium coarse grade” is defined as a material with a grain size from about 2.1 μm to about 3.4 μm; (VII) “coarse grade” is defined as a material with a grain size from about 3.5 μm to about 5.0 μm; and (VIII) “extra coarse grade” is defined as a material with a grain size greater than about 5.0 μm.

As used herein this disclosure, the term “cemented carbide” generally refers to a metal matrix composite material composed of a ceramic hard phase embedded and anchored in a matrix by typically a ductile metal binder element, such as for example cobalt (i.e. the metallic binder thus creating a metallic binder phase). The ceramic hard phase and the metallic binder phase powders can be processed into a wide variety of microstructures that achieve different mechanical and physical properties. Moreover, additional components can be added to the composition to help control and to refine the properties achieved by cemented carbide compositions. By controlling various parameters, including grain size, cobalt content, dotation (e.g., alloy carbides) and carbon content, a cemented carbide manufacturer can favorably tailor its performance to specific applications. A cemented carbide is ideally designed to provide the physical optimal properties of both a ceramic, such as high temperature resistance, hardness and fracture toughness, and those of a metal, such as the capability to undergo plastic deformation. The naturally ductile metal binder serves to offset the characteristic brittle behavior of the ceramic hard phase, thus raising its hardness, fracture toughness and durability. The combination of good hardness and fracture toughness makes cemented carbides ideal candidates for applications that involve significant amounts of wear, such as materials processing, tool inserts like insert blanks, structural components, etc. The ceramic hard phase of the cemented carbide is typically composed of refractory carbides, borides, nitrides or carbonitrides of metals from groups 4, 5 and 6 of the periodic table, such as, but not limited to tungsten, titanium, niobium, tantalum, chromium, vanadium, molybdenum, zirconium, hafnium, or any desired combination thereof. The ceramic hard phase can be present in the powder in any possible combination having the mentioned metals, and in a weight that is not inconsistent and incompatible with the objectives of the present subject matter. To qualify as a cemented carbide herein this disclosure, a cemented carbide generally has a ceramic hard phase constituted of at least 60 wt. % based on the total weight of the cemented carbide.

As used herein this disclosure, the term “about” is meant to mean plus or minus 5% of the numerical value of the number with which it is being used in the claims and herein this disclosure. Thus, “about” may be used to provide flexibility to a numerical range endpoint, in which, a given value may be “above” or “below” the given value. As such, for example a value of 50% may be intended to encompass a range, which may be defined by for example ranges like 47.5%-52.25%, 47.5%-52.5%, 47.75%-50%, 50%-52.5%, 48%-48.5%, 48%-48.75%, 48%-49%, 48%-49.5%, 48%-49.75%, 48%-50%, 48%-50.25%, 48%-50.5%, 48%-50.75%, 48%-51%, 48%-51.5%, 48%-51.75%, 48%-52%, 48%-52.25%, 48%-52.5%, 48.25%-48.5%, 48.25%-48.75%, 48.25%-49%, 48.25%-49.5%, 48.25%-49.75%, 48.25%-50%, 48.25%-50.25%, 48.25%-50.5%, 48.25%-50.75%, 48.25%-51%, 48.25%-51.25%, 48.25%-51.5%, 48.25%-51.75%, 48.25%-52%, 48.25%-52.25%, 48.25%-52.5%, 48.5%-48.75%, 48.5%-49%, 48.5%-49.5%, 48.5%-49.75%, 48.5%-50%, 48.5%-50.25%, 48.5%-50.5%, 48.5%-50.75%, 48.5%-51%, 48.5%-51.25%, 48.5%-51.5%, 48.5%-51.75%, 48.5%-52%, 48.5%-52.25%, 48.5%-52.5%, 49%-49.25%, 49%-49.5%, 49%-49.75%, 49%-50%, 49%-50.25%, 49%-50.5%, 49%-50.75%, 49%-51%, 49%-51.25%, 49%-51.5%, 49%-51.75%, 49%-52%, 49%-52.25%, 49%-52.5% 49.5%-49.75%, 49.5%-50%, 49.5%-50.25%, 49.5%-50.5%, 49.5%-50.75%, 49.5%-51%, 49.5%-51.5%, 49.5%-51.75%, 49.5%-52%, 49.5%-52.25%, 49.5%-52.5%, 49.75%-50%, 49.75%-50.25%, 49.75%-50.5%, 49.75%-50.75%, 49.75%-51%, 49.75%-51.25%, 49.75%-51.5%, 49.75%-51.75%, 49.75%-52%, 49.75%-52.25%, 49.75%-52.5%, 50%-50.25%, 50%-50.5%, 50%-50.75%, 50%-51%, 50%-51.25%, 50%-51.5%, 50%-52%, 50%-52.25%, 50%-52.5% etc.

As used herein this disclosure, the term “green body” refers to a material in the form of bonded powder or plates before the material has physically been sintered.

As used herein, “spherical” refers to the grains having a substantially round shape.

Wherever used throughout the disclosure, the term “generally” has the meaning of “typically” or “closely” or “within the vicinity or range of”.

As used herein, the term “substantially” refers to the complete or nearly complete extent or degree of an action, characteristic, property, state, structure, item, or result.

As used herein, the term “apparent density” refers to a mass of a unit volume of a powder, or particles of cemented carbide in a loose condition expressed in g/cm³. Thus, the term “apparent density” refers to the bulk density of a free-flowing powder and loosely packed powders of the cemented carbide exhibiting a pore space between the free-flowing particles of the cemented carbide. A prerequisite is that any given value for the “apparent density” requires the particles of the cemented carbide powder to be loosely packed, and moreover in a free-flowing state. Apparent density of sintered cemented particles can be determined according to ASTMB212 Standard Test Method for apparent density of free-flowing metal powders using a hall flowmeter funnel.

As used herein this disclosure, the term “free-flowing” refers to loosely packed cemented carbide powders displaying a pore space between each free-flowing particle of the cemented carbide powder with no physical restrictions, or barriers whatsoever, suppressing the free-flowing capacity of the particles of the cemented carbide powder.

As used herein this disclosure, “high-density cemented carbide” is meant to encompass cemented carbide powder having an apparent density ranging from at least about 5 g/cm³ to about 15 g/cm³.

### Methods of Manufacturing a High-Density Cemented Carbide for Binder Jet Additive Manufacturing

The current disclosure is based on the notion of manufacturing a high-density cemented carbide powder chiefly composed of a ceramic hard phase powder and a metallic binder phase powder used for binder jetting to 3D print an object by generally a dual sintering cycle process. A first pre-sintering process step is initially conducted to impart a densification to a RTP powder (i.e. composed of a mixture of a ceramic hard phase powder and a metallic binder phase powder). Next, this is followed by a second sintering process step to confer an enhanced densification, and to ultimately obtain a printable powder with a full density, and where the particles of the cemented carbide powder no longer sinter one to another. The obtained fully densified printable powder may thereafter advantageously be utilized in binder jetting to 3D print the object.

As would be apparent to one having ordinary skill in the art, a desired particle size of a cemented carbide powder mixture composed of a ceramic hard phase powder, a metallic binder phase powder and an organic binder can be achieved by a first milling operation typically for several hours (e.g. 8, 16, 32, 64 hours) under ambient conditions to obtain a slurry blend (i.e. 25° C., 298.15 K and a pressure of 101.325 kPa in a ball mill, an attritor mill, or a planetary mill). In some embodiments, instead of using a ball mill, an attritor mill, or a planetary mill as the physical machinery, ultrasonic mixing may instead suitably be the choice of blending method. Thus, in this case, ultrasonic mixing uses sound energy to effectively process for example powders, pastes, liquids, and combinations thereof with a breakthrough speed, quality and repeatability. Powders of nearly any size, material characteristic, or morphology are rapidly and thoroughly mixed using for example an acoustic mixer. Acoustic processing is frequently orders of magnitude faster than traditional technologies. Here, the acoustic mixer may for example employ a 60 Hz motion, which then causes each particle to randomly collide with adjacent particles, diverting their paths, colliding and then re-colliding with other particles behaving in equally chaotic fashion. The main purpose of the blending operation is to facilitate a good metallic binder distribution, and a good wettability between the components of the slurry blend. Subjecting the cemented carbide mixture composed of the ceramic hard phase powder, the metallic binder phase powder and the organic binder to the milling operation is key to strengthening the physical integrity of the milled cemented carbide powder mixture, and in some cases, to deagglomerate tungsten carbide (WC) crystals. An acceptable metallic binder distribution, and a good quality of wettability are fundamental and essential parameters for obtaining cemented carbide blend of stellar physical quality. On the other hand, if the metallic binder phase distribution, and wettability are of a rather bad quality, pores and cracks may undesirably be formed as a result of this in the final sintered body, which is detrimental to the produced cemented carbide.

As would be apparent to a skilled artisan, the milling is made by initially adding a milling liquid to a batch of powdered materials including a ceramic hard phase powder, a metallic binder phase powder and an organic binder mixture to first form a slurry composition. The milling liquid may be water, an alcohol such as but not limited to ethanol, methanol, isopropanol, butanol, cyclohexanol, an organic solvent in the likes of for example heptane, hexane, acetone or toluene, an alcohol mixture, an alcohol and a solvent mixture, or any combination thereof. The properties of the slurry composition are dependent on, among other things, the amount of the milling liquid that is added. Because the drying of the slurry composition requires energy, the amount of the used milling liquid to obtain the slurry composition should ideally be minimized to keep costs down. However, enough milling liquid needs to be added to achieve a pumpable slurry composition, and to avoid clogging of the system. Moreover, other compounds commonly known in the art to a skilled artisan can be added to the slurry composition e.g. dispersion agents, pH-adjusters, etc. Non-limiting examples of the organic binder(s) may be polyethylene glycol (PEG), paraffin, polyvinyl alcohol (PVA), long chain fatty acids, wax, or any combination thereof, added to the slurry composition prior to the milling typically from for example 15 vol. % and 25 vol. % (i.e. total volume % made up by each mentioned component) of the total volume of the formed slurry composition.

The milled slurry composition resulting in the slurry blend may next be spray-dried, freeze-dried, or vacuum-dried and granulated to advantageously provide free-flowing powder aggregates of for example a spherical shape. Alternatively, the slurry blend can be vacuum-dried to form a RTP powder.

In the case of spray-drying, the slurry blend containing the powdered materials (i.e. having a ceramic hard phase powder and a metallic binder phase powder) mixed with the organic liquid, and the organic binder(s) may be atomized through an appropriate nozzle in the drying tower, where small drops are instantaneously dried by horizontal inflow of a stream of a hot gas into the drying tower, for instance in a stream of nitrogen, argon, or air to form the spherical RTP powder agglomerates with free-flowing properties. As used herein this disclosure, “atomization” refers to a process, where a bulk liquid feed is converted into discrete droplets, greatly increasing the surface area of the feed liquid, and thereby increasing considerably the achievable rates of evaporation of a solvent (i.e. the milling liquid). The atomization stage is designed to create optimum conditions for evaporation of the solvent from the slurry composition, and to lead to an optimally dried RTP powder having desired free-flowing characteristics. Nozzles and rotary atomizers are used to form sprays. Drying towers may be equipped with just one nozzle, or a plurality of nozzles to form the spherical RTP powder agglomerates with free-flowing properties.

The RTP powder, which typically has a particle size that is below about 63 microns is next sieved. For sieving, a 200-mesh screen may appropriately be used, which passes through a powder characterized by displaying a particle size measuring less than about 74 microns. A skilled artisan having ordinary skill in the art of manufacturing high-density carbide powders for 3D printing would know that the mesh number correlates inversely with the powder particle size that is passed through the screen. That is the higher mesh number of a used screen or sieve, the smaller the particle size passing through the used screen or sieve. Thus, alternatively in other examples, for sieving, a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, or a 140-mesh screen may be employed, which respectively, pass through a powder characterized by exhibiting a particle size measuring less than about 4760 microns, less than about 3360 microns, less than about 2380 microns, less than about 1680 microns, less than about 1190 microns, less than about 840 microns, less than about 590 microns, less than about 420 microns, less than about 297 microns, less than about 250 microns, less than about 210 microns, less than about 177 microns, less than about 149 microns, or less than about 105 microns. One of ordinary skill in the would readily know different sieving methodologies, and non-limiting examples of such sieving techniques may for example include the following, but without limitation vibrational sieving, wet sieving, horizontal sieving, tap sieving, and air jet sieving.

The sieved RTP powder is afterwards subjected to a pre-sintering temperature elevation procedure in a first cycle. Typical temperatures for the pre-sintering in the first cycle may be employed at a temperature starting from about 500° C. and ending at about 1250° C., starting from about 500° C. and ending at about 1275° C., starting from about 500° C. and ending at about 1300° C., starting from about 500° C. and ending at about 1325° C., starting from about 520° C. and ending at about 1250° C., starting from about 520° C. and ending at about 1275° C., starting from about 520° C. and ending at about 1300° C., starting from about 520° C. and ending at about 1325° C., starting from about 550° C. and ending at about 1250° C., starting from about 550° C. and ending at about 1275° C., starting from about 550° C. and ending at about 1300° C., or starting from about 550° C. and ending at about 1325° C. This is typically performed in a reactive hydrogen (H₂) atmosphere generally with a hydrogen (H₂) flow rate applied at about 1000 liters/hour to about 6000 liters/hour, applied at about 2000 liters/hour to about 6000 liters/hour, applied at about 3000 liters/hour to about 6000 liters/hour, applied at about 4000 liters/hour to about 6000 liters/hour, or applied at about 5000 liters/hour to about 6000 liters/hour. The temperature may typically be increased constantly at a rate of for example about 0.70° C./min. In some examples, the temperature may be increased in tandem sequentially at a rate of about 2° C./min. shifted to about 10° C./min., or for example at a rate of about 2° C./min. changed to about 5° C./min. The heating may be performed for about 15 minutes to about 30 minutes, or for about 30 minutes to about 45 minutes in the sintering furnace at the highest temperature of a given temperature range. The particular type of heating pattern chosen is performed for the specific amount of time, in a manner, that confers a desired phase-transformation during the first pre-sintering cycle.

In general, the pre-sintering temperature elevation procedure in the first cycle may be conducted in a reactive hydrogen (H₂) atmosphere typically applying a hydrogen (H₂) pressure of up to about 35 mbar. In some examples, the applied hydrogen (H₂) pressure is ranging from about 5 mbar to about 35 mbar. In other examples, the applied hydrogen (H₂) pressure is ranging from about 10 mbar to about 35 mbar. In yet other examples, the applied hydrogen (H₂) pressure is ranging from about 15 mbar to about 35 mbar. In still other examples, the applied hydrogen (H₂) pressure is ranging from about 20 mbar to about 35 mbar. In further other examples, the applied hydrogen (H₂) pressure is ranging from about 25 mbar to about 35 mbar. In even other examples, the applied hydrogen (H₂) pressure is ranging from about 30 mbar to about 35 mbar.

The applied hydrogen (H₂) pressure may also range from about 5 mbar to about 10 mbar, from about 10 mbar to about 15 mbar, from about 15 mbar to about 20 mbar, from about 5 mbar to about 20 mbar, from about 5 mbar to about 25 mbar, from about 5 mbar to about 27 mbar, from about 5 mbar to about 30 mbar, from about 5 mbar to about 32 mbar, from about 15 mbar to about 25 mbar, from about 20 mbar to about 25 mbar, from about 20 mbar to about 27 mbar, from about 20 mbar to about 30 mbar, from about 20 mbar to about 32 mbar, from about 22 mbar to about 30 mbar, from about 25 mbar to about 30 mbar, from about 27 mbar to about 30 mbar, from about 27 mbar to about 32 mbar, or from about 27 mbar to about 35 mbar.

Next, the pre-sintered RTP powder in the first cycle subsequently undergoes a sintering consolidation process in a second cycle to ultimately form the sintered printable powder, which sintered printable powder is eventually used for binder jetting to 3D print the object after undergoing a sieving operation. In general, the sintering consolidation process in the second cycle may appropriately be conducted in an inert argon (Ar) atmosphere by typically applying an argon (Ar) pressure of up to about 50 mbar suitably applied at a flow rate of about 30 liters/hour to about 300 liters/hour, at a flow rate of about 100 liters/hour to about 300 liters/hour, at a flow rate of about 150 liters/hour to about 300 liters/hour, at a flow rate of about 200 liters/hour to about 300 liters/hour, or at a flow rate of about 250 liters/hour to about 300 liters/hour. In some examples, the applied argon (Ar) pressure is ranging from about 10 mbar to about 50 mbar with an argon (Ar). In other examples, the applied argon (Ar) pressure is ranging from about 15 mbar to about 50 mbar. In yet other examples, the applied argon (Ar) pressure is ranging from about 20 mbar to about 50 mbar. In still other examples, the applied argon (Ar) pressure is ranging from about 25 mbar to about 50 mbar. In even other examples, the applied argon (Ar) pressure is ranging from about 30 mbar to about 50 mbar. In further other examples, the applied argon (Ar) pressure is ranging from about 35 mbar to about 50 mbar. In still other embodiments, the applied argon (Ar) pressure is ranging from about 40 mbar to about 50 mbar. In even other embodiments, the applied argon (Ar) pressure is ranging from about 45 mbar to about 50 mbar.

The applied argon (Ar) pressure may also range from about 10 mbar to about 15 mbar, from about 10 mbar to about 20 mbar, from about 15 mbar to about 20 mbar, from about 15 mbar to about 22 mbar, from about 15 mbar to about 25 mbar, from about 15 mbar to about 27 mbar, from about 20 mbar to about 25 mbar, from about 10 mbar to about 25 mbar, from about 25 mbar to about 30 mbar, from about 25 mbar to about 35 mbar, from about 30 mbar to about 35 mbar, from about 30 mbar to about 37 mbar, from about 30 mbar to about 40 mbar, from about 30 mbar to about 45 mbar, from about 35 mbar to about 40 mbar, from about 25 mbar to about 40 mbar, from about 25 mbar to about 45 mbar, or from about 40 mbar to about 45 mbar. Typical temperatures for the sintering in the second cycle may be applied at a temperature starting from about 500° C. and ending at about 1250° C., starting from about 500° C. and ending at about 1275° C., starting from about 500° C. and ending at about 1300° C., starting from about 500° C. and ending at about 1325° C., starting from about 520° C. and ending at about 1250° C., starting from about 520° C. and ending at about 1275° C., starting from about 520° C. and ending at about 1300° C., starting from about 520° C. and ending at about 1325° C., starting from about 550° C. and ending at about 1250° C., starting from about 550° C. and ending at about 1275° C., starting from about 550° C. and ending at about 1300° C., or starting from about 550° C. and ending at about 1325° C. The specific sintering temperature range is chosen in a manner that will confer a sufficient melting of the metallic binder phase. During this process, the metallic binder phase eventually will enter the liquid stage, while the carbide grains (i.e. having much higher melting point) will remain in a solid stage. At the sintering temperature, the metallic binder and the carbide grains form a eutectic liquid phase, where the carbide grains are positioned and subsequently coated with the metallic binder. As a result of this process, the metallic binder is embedding and cementing the carbide grains, thereby creating the metal matrix composite with its distinctive material properties. The temperature may typically be elevated constantly at a rate of for example about 0.70° C./min. In some examples, the temperature may be increased in tandem sequentially at a rate of about 2° C./min. switched to about 10° C./min., or for instance at a rate of about 2° C./min. shifted to about 5° C./min. The heating may be maintained for about 15 minutes to about 30 minutes, or for about 30 minutes to about 45 minutes in the sintering furnace at the highest temperature of a given temperature range, until the desired phase-transformation has taken place during the second sintering cycle. A cooling procedure may subsequently be performed typically via a temperature drop to about 25° C. in generally a time span of about 2 hours.

The sintered printable powder, which typically has a particle size that is about 25 microns is thereafter sieved. For sieving, a 400-mesh screen may appropriately be used, which passes through a powder characterized by exhibiting a particle size measuring less than about 37 microns. A person having ordinary skill in the art of manufacturing high-density carbide powders for 3D printing would know that the mesh number inversely correlates with the powder particle size that is passed through the screen. In other words, the higher mesh number of a used screen or sieve, the smaller the particle size passing through the used screen or sieve. Thus, alternatively in other examples, for sieving a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, 140-mesh screen, 200-mesh screen, 230-mesh screen, 270-mesh screen, or a 325-mesh screen may be used, which respectively, pass through a powder characterized by having a particle size measuring less than about 4760 microns, less than about 3360 microns, less than about 2380 microns, less than about 1680 microns, less than about 1190 microns, less than about 840 microns, less than about 590 microns, less than about 420 microns, less than about 297 microns, less than about 250 microns, less than about 210 microns, less than about 177 microns, less than about 149 microns, less than about 105 microns, less than about 74 microns, less than about 62 microns, less than about 53 microns, or less than about 44 microns. One of ordinary skill in the would readily know different sieving methodologies, and non-limiting examples of such sieving techniques may for example include the following, but without limitation vibrational sieving, wet sieving, horizontal sieving, tap sieving, and air jet sieving.

For determining a specific particle size of the RTP powder and the printable powder, one having ordinary skill in the art would readily be familiar with the techniques of employing either dynamic digital image analysis (DIA), static laser light scattering (SLS) also known as laser diffraction, or by visual measurement by electron microscopy, a technique known as image analysis and light obscuration. Each method covers a characteristic size range within which measurement is possible. These ranges partly overlap. However, the results for measuring the same sample may vary all depending on the particular method that is used. A skilled artisan who wants to determine particle sizes or particle size distributions would readily know how each mentioned method is commonly performed and practiced. Thus, the reader is directed to for example, (i) “Comparison of Methods. Dynamic Digital Image Analysis, Laser Diffraction, Sieve Analysis”, Retsch Technology and (ii) the scientific publication by Kelly et al., “Graphical comparison of image analysis and laser diffraction particle size analysis data obtained from the measurements of nonspherical particle systems”, AAPS PharmSciTech. 2006 Aug. 18; Vol.7 (3): 69, to further gain insight into each procedure and methodology, all of which documents, are incorporated herein by reference in their entirety.

Manufacturing techniques contemplated herein for 3D printing may include the following, but are not limited to for example, binder jetting, fused deposition modeling (FDM), material jetting, electron beam powder bed, or directed energy deposition as described in ASTM (American Society for Testing and Materials) Committee F-42 on Additive Manufacturing Technologies.

Binder jetting can be used to 3D print a green body formed of the sintered printable cemented carbide powder. As described herein, the sintered printable cemented carbide particles may be 3D printed into a green body by employing one or more ALM techniques. Theoretically, any ALM technique that is operable to convert the sintered printable cemented carbide powder into a green body during the 3D printing can practically be employed. In the binder jetting process, an electronic file detailing the design parameters of the green body is provided. The binder jetting apparatus spreads a first layer of the sintered printable cemented carbide powder in a build box. Next, a printhead moves over the powder layer depositing a liquid binder according to particular design parameters for that unique layer. The formed layer is thereafter dried and cured, and the build box is lowered. A new particular layer of a sintered printable cemented carbide powder is spread according to the design parameters on top of the previously formed and cured layer, and the process is sequentially repeated until the entire green body has eventually been 3D printed. In some embodiments, other 3D printing apparatus than binder jetting can be used to print a green body, or a green article from the sintered printable cemented carbide powder.

The 3D printed green body is thereafter heat-cured in an oven typically for about 6 hours at a temperature starting from about 150° C. and ending at about 180° C., or starting from about 180° C. and ending at about 200° C. Here, the sole purpose of the heat-curing is basically that the organic binder is heat-cured, thereby strengthening and physically holding together the 3D printed green body much like a glue. Finally, following the heat-curing, the 3D printed green body is next sintered at a temperature starting from about 1500° C. and ending at about 1560° C., or starting from about 1560° C. and ending at about 1600° C., thus concluding the whole process of 3D printing an object by binder jetting.

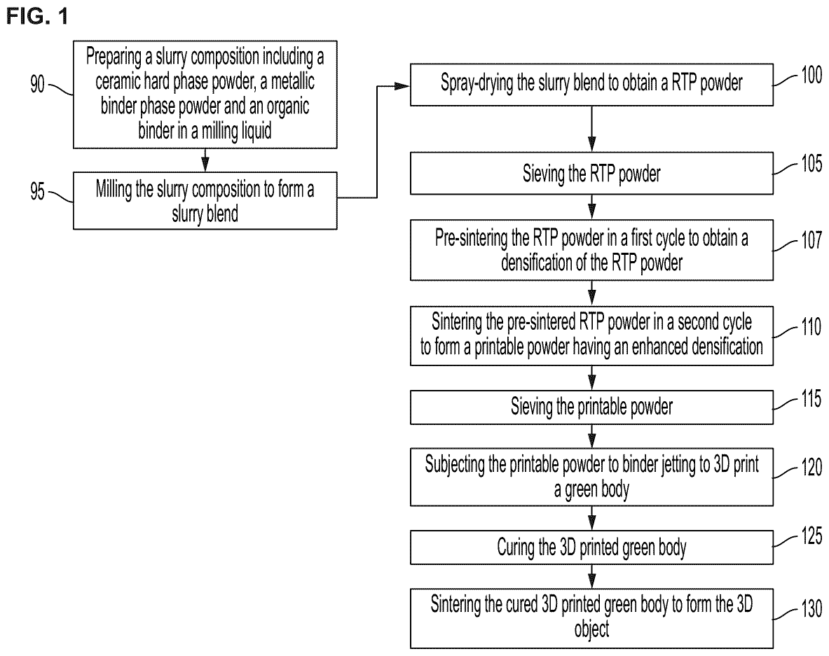

Turning now to FIG. 1, this figure depicts a flow diagram showing all the individual aforementioned process steps of manufacturing a high density cemented carbide powder for binder jetting to 3D print an object in accordance with an exemplary embodiment of the present subject matter.

As demonstrated in FIG. 1, in step 90, a slurry composition is first prepared including a ceramic hard phase powder, a metallic binder phase powder and an organic binder in a milling liquid as described in paragraph ¶ [0062]. This slurry composition is next milled in step 95 as described in paragraph ¶ to obtain a slurry blend, which slurry blend, is thereafter spray-dried in step 100 to form a RTP powder as disclosed in paragraphs ¶ [0063]-[0064]. In step 105, after sieving the RTP powder as disclosed in paragraph ¶ [0065], the RTP powder is next pre-sintered in a first cycle to obtain a densification of the RTP powder as disclosed in paragraphs ¶ [0066]-[0068] in step 107. The pre-sintered RTP powder is subsequently sintered in a second cycle in step 110 to form a printable powder having an enhanced densification as described in paragraphs ¶ [0070]. After sieving the formed printable powder in step 115 as disclosed in paragraph ¶ [0071], the formed printable powder is subjected to binder jetting to 3D print a green body in step 120 as disclosed in paragraphs ¶ [0073]-[0074]. The 3D printed green body is subsequently heat-cured in step 125 as disclosed in paragraph ¶ [0075], and the process is finally concluded in step 130 by sintering the heat-cured 3D printed green body to eventually form the 3D object as described in paragraph ¶ [0075].

A ceramic hard phase may be present in the RTP powder suitably composed of hard metals generally of carbides, borides, nitrides and/or carbonitrides, however most typically of tungsten carbide. In certain examples, the ceramic hard phase of the cemented carbide composition is composed of for example carbides, borides, nitrides or carbonitrides of at least one metal selected from groups IVB, VB and VIB of the periodic table, or any desired combinations thereof. In certain particular embodiments, the ceramic hard phase is composed of at least one of carbides, borides, nitrides or carbonitrides of tungsten, titanium, tantalum, niobium, vanadium, zirconium, molybdenum, chromium, or hafnium, or any desired combinations thereof. In certain other particular embodiments, the ceramic hard phase is composed of tungsten carbide, tantalum carbide, niobium carbide, vanadium carbide, molybdenum carbide, chromium carbide, zirconium carbide, hafnium carbide, titanium carbide, niobium carbide, or any desired combinations thereof. The ceramic hard phase encompassing the mentioned metal carbides, borides, nitrides or carbonitrides may incorporate them in any combination that is not inconsistent and incompatible with the objectives of the present subject matter.

The ceramic hard phase may typically be present in the RTP powder from about 60 wt. % to about 95 wt. % based on the total weight of the cemented carbide. In some examples, the ceramic hard phase is present from about 65 wt. % to about 95 wt. % based on the total weight of the cemented carbide. In other examples, the ceramic hard phase is present from about 70 wt. % to about 95 wt. % based on the total weight of the cemented carbide. In yet other examples, the ceramic hard phase is present from about 75 wt. % to about 95 wt. % based on the total weight of the cemented carbide. In still other examples, the ceramic hard phase is present from about 80 wt. % to about 95 wt. % based on the total weight of the cemented carbide. In further other examples, the ceramic hard phase is present from about 85 wt. % to about 95 wt. % based on the total weight of the cemented carbide. In even other examples, the ceramic hard phase is present from about 90 wt. % to about 95 wt. % based on the total weight of the cemented carbide.

The ceramic hard phase may also be present in the RTP powder from about 60 wt. % to about 65 wt. %, from about 60 wt. % to about 70 wt. %, from about 65 wt. % to about 70 wt. %, from about 65 wt. % to about 75 wt. %, from about 70 wt. % to about 75 wt. %, from about 60 wt. % to about 75 wt. %, from about 60 wt. % to about 80 wt. %, from about 62 wt. % to about 80 wt. %, from about 65 wt. % to about 80 wt. %, from about 67 wt. % to about 80 wt. %, from about 70 wt. % to about 80 wt. %, from about 75 wt. % to about 80 wt. %, from about 60 wt. % to about 85 wt. %, from about 65 wt. % to about 85 wt. %, from about 67 wt. % to about 85 wt. %, from about 70 wt. % to about 85 wt. %, from about 75 wt. % to about 85 wt. %, from about 80 wt. % to about 85 wt. %, from about 60 wt. % to about 90 wt. %, from about 65 wt. % to about 90 wt. %, from about 67 wt. % to about 90 wt. %, from about 70 wt. % to about 90 wt. %, from about 75 wt. % to about 90 wt. %, from about 77 wt. % to about 90 wt. %, from about 80 wt. % to about 90 wt. %, from about 85 wt. % to about 90 wt. %, from about 60 wt. % to about 92 wt. %, from about 65 wt. % to about 92 wt. %, from about 67 wt. % to about 92 wt. %, from about 70 wt. % to about 92 wt. %, from about 75 wt. % to about 92 wt. %, from about 77 wt. % to about 92 wt. %, from about 80 wt. % to about 92 wt. %, or from about 85 wt. % to about 92 wt. % based on the total weight of the cemented carbide.

The RTP powder may further appropriately include at least one or more metallic binders.

The metallic binder may typically be cobalt. In certain embodiments, the metallic binder can ideally include one or more transition metals of Group VIIIB of the periodic table. In certain particular embodiments, the metallic binder may equally be a cobalt-based alloy. A cobalt-based metallic alloy binder, in certain other particular embodiments, may include a cobalt-transition metal alloy. For example, transition metals of the cobalt-based metallic alloy binder can appropriately be selected from one or more of molybdenum, ruthenium, rhenium, rhodium, platinum, palladium, manganese, copper, iron, nickel, or any desired combinations thereof. In other embodiments, the transition metals including at least one of molybdenum, ruthenium, rhenium, rhodium, platinum, palladium, manganese, copper, iron, nickel, or any desired combinations thereof may be used without the inclusion of cobalt. In yet other examples, the metallic binder may further include metalloids like silicon and/or can include aluminum.

The metallic binder can be present in the RTP powder in any amount that is not inconsistent and incompatible with the objectives and principles of the present disclosure. The metallic binder may generally be present in the RTP powder in an amount of about 1 wt. % to about 30 wt. % based on the total weight of the cemented carbide. In some examples, the metallic binder is present in the RTP powder in an amount of about 1 wt. % to about 3 wt. % based on the total weight of the cemented carbide. In other examples, the metallic binder is present in the RTP powder in an amount of about 1 wt. % to about 5 wt. % based on the total weight of the cemented carbide. In yet other examples, the metallic binder is present in the RTP powder in an amount of about 1 wt. % to about 7 wt. % based on the total weight of the cemented carbide. In still other examples, the metallic binder is present in the RTP powder in an amount of about 1 wt. % to about 10 wt. % based on the total weight of the cemented carbide. In further other examples, the metallic binder is present in the RTP powder in an amount of about 1 wt. % to about 15 wt. % based on the total weight of the cemented carbide. In even other examples, the metallic binder is present in the RTP powder in an amount of about 1 wt. % to about 20 wt. % based on the total weight of the cemented carbide. In still other embodiments, the metallic binder is present in the RTP powder in an amount of 1 about wt. % to about 25 wt. % based on the total weight of the cemented carbide. In even other embodiments, the metallic binder is present in the RTP powder in an amount of about 1 wt. % to about 27 wt. % based on the total weight of the cemented carbide.

The metallic binder may also be present in the RTP powder in an amount of about 1 wt. % to about 2 wt. %, from about 2 wt. % to about 5 wt. %, from about 5 wt. % to about 7 wt. %, from about 3 wt. % to about 7 wt. %, from about 7 wt. % to about 10 wt. %, about 10.1 wt. %, about 10.2 wt. %, about 10.3 wt. %, about 10.4 wt. %, about 10.5 wt. %, about 10.6 wt. %, about 10.7 wt. %, about 10.8 wt. %, about 10.9 wt. %, from about 7 wt. % to about 13 wt. %, from about 7 wt. % to about 15 wt. %, from about 7 wt. % to about 17 wt. %, from about 7 wt. % to about 20 wt. %, from about 7 wt. % to about 22 wt. %, from about 7 wt. % to about 25 wt. %, from about 7 wt. % to about 27 wt. %, from about 7 wt. % to about 30 wt. %, from about 10 wt. % to about 13 wt. %, from about 10 wt. % to about 15 wt. %, from about 10 wt. % to about 17 wt. %, from about 10 wt. % to about 20 wt. %, from about 10 wt. % to about 22 wt. %, from about 10 wt. % to about 25 wt. %, from about 15 wt. % to about 20 wt. %, from about 15 wt. % to about 22 wt. %, from about 15 wt. % to about 25 wt. %, from about 15 wt. % to about 27 wt. %, from about 10 wt. % to about 30 wt. %, from about 15 wt. % to about 30 wt. %, from about 17 wt. % to about 30 wt. %, from about 20 wt. % to about 30 wt. %, from about 22 wt. % to about 30 wt. %, from about 25 wt. % to about 30 wt. %, or from about 27 wt. % to about 30 wt. % based on the total weight of the cemented carbide.

The processed RTP powder and the printable powder disclosed herein this application may have an apparent density, respectively, spanning a range from at least about 5 g/cm³ to about 15 g/cm³. In some examples, the apparent density of the processed RTP powder and the printable powder is in a range from at least about 7 g/cm³ to about 15 g/cm³. In other examples, the apparent density of the processed RTP powder and the printable powder is in a range from at least about 10 g/cm³ to about 15 g/cm³. In yet other examples, the apparent density the processed RTP powder and the printable powder is in a range from at least about 12 g/cm³ to about 15 g/cm³. In still other examples, the apparent density of the processed RTP powder and the printable powder is in a range from at least about 14 g/cm³ to about 15 g/cm³.

The apparent density of the processed RTP powder and the printable powder may also be in a range from at least about 5 g/cm³ to about 6 g/cm³, from at least about 5 g/cm³ to about 7 g/cm³, from at least about 5 g/cm³ to about 8 g/cm³, from at least about 5 g/cm³ to about 9 g/cm³, from at least about 5 g/cm³ to about 10 g/cm³, from at least about 5 g/cm³ to about 11 g/cm³, from at least about 5 g/cm³ to about 12 g/cm³, from at least about 5 g/cm³ to about 13 g/cm³, from at least about 5 g/cm³ to about 14 g/cm³, 6 g/cm³ to about 7 g/cm³, from at least about 6 g/cm³ to about 8 g/cm³, from at least about 6 g/cm³ to about 9 g/cm³, from at least about 6 g/cm³ to about 10 g/cm³, from at least about 6 g/cm³ to about 11 g/cm³, from at least about 6 g/cm³ to about 12 g/cm³, from at least about 6 g/cm³ to about 13 g/cm³, from at least about 6 g/cm³ to about 14 g/cm³, from at least about 6 g/cm³ to about 15 g/cm³ from at least about 7 g/cm³ to about 8 g/cm³, from at least about 7 g/cm³ to about 9 g/cm³, from at least about 7 g/cm³ to about 10 g/cm³, from at least about 7 g/cm³ to about 11 g/cm³, from at least about 7 g/cm³ to about 12 g/cm³, from at least about 7 g/cm³ to about 13 g/cm³, from at least about 7 g/cm³ to about 14 g/cm³, from at least about 8 g/cm³ to about 9 g/cm³, from at least about 8 g/cm³ to about 10 g/cm³, from at least about 8 g/cm³ to about 11 g/cm³, from at least about 8 g/cm³ to about 12 g/cm³, from at least about 8 g/cm³ to about 13 g/cm³, from at least about 8 g/cm³ to about 14 g/cm³, from at least about 8 g/cm³ to about 15 g/cm³, from at least about 9 g/cm³ to about 10 g/cm³, from at least about 9 g/cm³ to about 11 g/cm³, from at least about 9 g/cm³ to about 12 g/cm³, from at least about 9 g/cm³ to about 13 g/cm³, from at least about 9 g/cm³ to about 14 g/cm³, from at least about 9 g/cm³ to about 15 g/cm³, from at least about 10 g/cm³ to about 11 g/cm³, from at least about 10 g/cm³ to about 12 g/cm³, from at least about 10 g/cm³ to about 13 g/cm³, from at least about 10 g/cm³ to about 14 g/cm³, from at least about 11 g/cm³ to about 12 g/cm³, from at least about 11 g/cm³ to about 13 g/cm³, from at least about 11 g/cm³ to about 14 g/cm³, or from at least about 11 g/cm³ to about 15 g/cm³, from at least about 12 g/cm³ to about 13 g/cm³, from at least about 12 g/cm³ to about 14 g/cm³, from at least about 13 g/cm³ to about 14 g/cm³, or from at least about 13 g/cm³ to about 15 g/cm³.

The yield of the formed printable powder may typically be from about 60% to about 90% or may be at least 90%. In some examples, the yield of the formed printable powder is from about 70% to about 90%. In other examples, the yield of the formed printable powder is from about 80% to about 90%. In still other examples, the yield of the formed printable powder is from about 85% to about 90%. In even other examples, the yield of the formed printable powder is at least 90%.

The yield of the formed printable powder may also be from about 60% to about 65%, from about 60% to about 70%, from about 60% to about 75%, from about 60% to about 80%, from about 60% to about 85%, from about 65% to about 70%, from about 65% to about 75%, from about 65% to about 80%, from about 65% to about 85%, from about 65% to about 90%, from about 70% to about 75%, from about 70% to about 80%, from about 70% to about 85%, from about 75% to about 80%, from about 75% to about 85%, from about 75% to about 90%, or from about 80% to about 85%.

### EXAMPLE

The following example is put forth so as to provide those of ordinary skill in the art with a complete disclosure and description of how to make and use the described subject matter and is not intended to limit the scope of what the inventors regard as their disclosure nor is it intended to represent that the experiment below is all or the only experiment performed. Efforts have been made to ensure accuracy with respect to numbers used but some experimental errors and deviations should be accounted for.

### Example 1

Printable Powder Exhibits a Higher Apparent Density than Pre-Sintered RTP Powder

TABLE 1

| Sample | Apparent Density (g/cm³) |
|---|---|
| RTP powder | 3.27 g/cm³ |
| Pre-sintered RTP powder (1. | 5.25 g/cm³ |
| cycle) | |
| Sintered RTP powder (2. | 5.45 g/cm³ |
| cycle) => Printable powder | |

The apparent density of a high density cemented carbide powder for binder jetting to 3D print an object in accordance with an exemplary embodiment of the present subject matter was determined after different processing stages. First, the apparent density of RTP powder, formed after spray-drying a slurry blend, was determined. Next, the apparent density of pre-sintered RTP powder in a first cycle was obtained. Finally, the apparent density of sintered RTP powder in a second cycle was attained. To achieve the foregoing, RTP powder having a particle size below about 63 microns was sieved using a a 200-mesh screen. The apparent density of the RTP powder was obtained. The RTP powder was next pre-sintered in the first cycle at about 1250° C. for about 30 minutes in a furnace by using zirconia crucibles to increase the density, and to further maintain the round spherical morphology of the RTP powder particles. The RTP powder was crushed to break any remaining chunks by milling the RTP powder for about 30 minutes in an attritor mill. The milled RTP powder was next sieved through a 200-mesh screen to remove any remaining agglomerates, and the apparent density was measured. The RTP powder was thereafter sintered in a second cycle at about 1250° C. for about 30 minutes to increase the apparent density and to form a printable powder. The formed printable powder was afterwards crushed to break any remaining chunks by milling the printable powder for about 30 minutes in an attritor mill. The milled printable powder having a particle size about 25 microns was next sieved through a 400-mesh screen to remove any present agglomerates, and to keep the desired particle size, and the apparent density was measured. Finally, the obtained fully densified printable powder can next be used in binder jetting to 3D print the object. The obtained results are shown in TABLE 1. As it is evident, TABLE 1 demonstrates that the apparent density increased with each increasing number of the sintering cycle. The non-sintered RTP powder displayed an apparent density of 3.27 g/cm³. When the RTP powder was pre-sintered in the first cycle, the pre-sintering procedure of the RTP powder resulted in a nearly 60.5% increase in the apparent density from 3.27 g/cm³ to 5.25 g/cm³. When the RTP powder was sintered in the second cycle, thereby finally forming the fully densified printable powder, the apparent density further increased from 5.25 g/cm³ to 5.45 g/cm³, hence an increase of the apparent density of another approximately 3.8%.

Although the present disclosure has been described in connection with embodiments thereof, it will be appreciated by those skilled in the art that additions, deletions, modifications, and substitutions not specifically described may be made without departure from the spirit and scope of the disclosure as defined in the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The illustrative embodiments described in the detailed description, drawings, and claims are not meant to be limiting. Other embodiments may be utilized, and other changes may be made, without departing from the spirit or scope of the subject matter presented here.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. The upper and lower limits of these smaller ranges which can independently be included in the smaller ranges is also encompassed within the disclosure, subject to any specifically excluded limit in the stated range. Where the stated range includes one or both of the limits, ranges excluding either both of those included limits are also included in the disclosure.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Additionally, for example any sequence(s) and/or temporal order of sequence of the system and method that are described herein this disclosure are illustrative and should not be interpreted as being restrictive in nature. Accordingly, it should be understood that the process steps may be shown and described as being in a sequence or temporal order, but they are not necessarily limited to being carried out in any particular sequence or order. For example, the steps in such processes or methods generally may be carried out in various different sequences and orders, while still falling within the scope of the present disclosure.

Finally, the discussed application publications and/or patents herein are provided solely for their disclosure prior to the filing date of the described disclosure. Nothing herein should be construed as an admission that the described disclosure is not entitled to antedate such publication by virtue of prior disclosure.

1. A method of manufacturing a three-dimensional (3D) object, comprising:
preparing a slurry composition comprising a ceramic hard phase powder, a metallic binder phase powder and an organic binder in a milling liquid;
milling the slurry composition to form a slurry blend;
spray-drying the slurry blend to obtain a RTP powder;
sieving the RTP powder;
pre-sintering the RTP powder in a first cycle to obtain a densification of the RTP powder;
sintering the pre-sintered RTP powder in a second cycle to form a printable powder having an enhanced densification;
sieving the printable powder;
subjecting the printable powder to binder jetting to 3D print a green body;
curing the 3D printed green body; and
sintering the cured 3D printed green body to form the 3D object.

2. The method of manufacturing a three-dimensional (3D) object of claim 1, wherein the RTP powder is free-flowing.

3. The method of manufacturing a three-dimensional (3D) object of claim 1, wherein the pre-sintering in the first cycle is performed at a temperature starting from about 550° C. and ending at about 1250° C.

4. The method of manufacturing a three-dimensional (3D) object of claim 3, wherein the pre-sintering in the first cycle is performed in an atmosphere with a hydrogen pressure up to about 35 mbar applied with a flow of hydrogen up to about 6000 liters/hour.

5. The method of manufacturing a three-dimensional (3D) object of claim 3, wherein the pre-sintering in the first cycle is performed for about 15 minutes to about 30 minutes.

6. (canceled)

7. The method of manufacturing a three-dimensional (3D) object of claim 1, wherein the sintering in the second cycle is performed at a temperature starting from about 550° C. and ending at about 1250° C.

8. The method of manufacturing a three-dimensional (3D) object of claim 7, wherein the sintering in the second cycle is performed in an atmosphere with an argon pressure up to about 50 mbar applied with a flow of argon up to about 300 liters/hour.

9. The method of manufacturing a three-dimensional (3D) object of claim 7, wherein the sintering in the second cycle is performed for about 15 minutes to about 30 minutes.

10. (canceled)

11. The method of manufacturing a three-dimensional (3D) object of claim 1, wherein a yield of the formed printable powder is from about 60% to about 90%.

12.-15. (canceled)

16. The method of manufacturing a three-dimensional (3D) object of claim 1, wherein an apparent density of the RTP powder and the printable powder ranges from at least about 5 g/cm³ to about 15 g/cm³.

17. The method of manufacturing a three-dimensional (3D) object of claim 1, wherein the ceramic hard phase comprises one or more of tungsten carbide (WC), titanium cabide (TIC), tantalum carbide (TaC), niobium carbide (NbC), vanadium carbide (VC), zirconium carbide (ZrC), molybdenum carbide (Mo₂C) or hafnium carbide (HfC), or any combinations thereof.

18. The method of manufacturing a three-dimensional (3D) object of claim 17, wherein the ceramic hard phase comprises WC.

19. The method of manufacturing a three-dimensional (3D) object of claim 1, wherein the metallic binder phase powder comprises cobalt.

20. The method of manufacturing a three-dimensional (3D) object of claim 1, wherein the RTP powder is sieved through a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, a 140-mesh screen, or a 200-mesh screen.

21. The method of manufacturing a three-dimensional (3D) object of claim 1, wherein the printable powder is sieved through a 4-mesh screen, 6-mesh screen, 8-mesh screen, 12-mesh screen, 16-mesh screen, 20-mesh screen, 30-mesh screen, 40-mesh screen, 50-mesh screen, 60-mesh screen, 70-mesh screen, 80-mesh screen, 100-mesh screen, 140-mesh screen, 200-mesh screen, 230-mesh screen, 270-mesh screen, a 325-mesh screen, or a 400-mesh screen.

22. The method of manufacturing a three-dimensional (3D) object of claim 1, wherein the curing the 3D printed green body is performed at a temperature starting from about 150° C. and ending at about 180° C.

23. (canceled)

24. The method of manufacturing a three-dimensional (3D) object of claim 22, wherein the curing the 3D printed green body is performed for up to about 6 hours.

25. The method of manufacturing a three-dimensional (3D) object of claim 1, wherein the sintering the cured 3D printed green body is performed at a temperature starting from 1500° C. and ending at about 1560° C.

26. The method of manufacturing a three-dimensional (3D) object of claim 1, wherein the sintering the cured 3D printed green body is performed at a temperature starting from 1560° C. and ending at about 1600° C.

27. The method of manufacturing a three-dimensional (3D) object of claim 1, wherein the printable powder is fully densified.
